(19) United States
(12) Patent Application Publication
(10) Pub. No.: US 2024/0427159 A1
(43) Pub. Date: Dec. 26, 2024

(54) HEAD SIZE MEASUREMENT BASED ON NON-CONTACT SENSOR(S)

(71) Applicant: Meta Platforms Technologies, LLC, Menlo Park, CA (US)

(72) Inventors: Wei Lu, San Jose, CA (US); Puneet Gupta, Milpitas, CA (US)

(21) Appl. No.: 18/212,615

(22) Filed: Jun. 21, 2023

(51) Int. Cl. G02B 27/01; G01D 5/24

(52) U.S. Cl. CPC G02B 27/0179; G01D 5/24; G02B 27/0176; G02B 2027/0154; G02B 2027/0161; G02B 2027/0181

(57) ABSTRACT

A head-mounted device may include a frame, a display coupled to the frame, a front head-engaging structure coupled to the frame, a retention mechanism configured to secure the front head-engaging structure to the head of the user, and one or more non-contact sensor(s) disposed on one or more of the frame, the display, the retention mechanism, and/or the front head-engaging structure. The non-contact sensor(s) may be configured to detect a measurement of the head of the user. In some examples, the measurement may include a head circumference, a size and/or shape of the head. In some examples, the head-mounted device may dynamically adjust a length of the retention mechanism based in part on the sensor data received from the one or more non-contact sensor(s).

### BACKGROUND

Conventional head-mounted devices, such as augmented reality (AR) or virtual reality (VR) headsets, therapy helmets, fashion hats, etc. do not currently have a way of measuring a head circumference, size, and/or shape of a head of a user when worn. In pediatric care, a healthcare provider may routinely measure a head circumference of a child for head modeling therapy, which requires frequent doctor visits. Ordering glasses or hats online requires knowing one's head measurements. However, current tools such as measuring tape and mechanical hat sizing tools are inconvenient and not always accurate. Furthermore, in the case of an AR/VR headset, a user must manually adjust a size of the device each time the device is worn.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic diagram of a head measurement system in accordance with an example of the present disclosure.

FIG. 2 is perspective view of an example head-mounted device including one or more non-capacitive sensors in accordance with an example of the present disclosure.

FIG. 3 is a perspective view of another example head-mounted device including one or more non-capacitive sensors in accordance with an example of the present disclosure.

FIG. 4 illustrates an example method for adjusting a length of a retention mechanism associated with a head-mounted device as described herein.

FIG. 5 illustrates an example head measurement system usable to implement techniques such as those described herein.

### DETAILED DESCRIPTION

This application describes head-mounted devices with one or more non-contact sensors (e.g., non-contact capacitive proximity sensors) that are configured to measure a head circumference, size, and/or shape of a head of a user. A head mounted-device can include, but is not limited to, an extended reality headset (e.g., augmented reality, virtual reality, and/or mixed reality headsets), glasses, helmets, hats, or other devices worn on the head, neck, or face of the user which may be referred to herein simply as head-mounted devices. According to at least one example, a head-mounted device may include a frame, a display coupled to the frame and configured to present computer-generated content, a front head-engaging structure coupled to the frame and configured to engage a front portion of a head of a user, a retention mechanism configured to secure the front head-engaging structure to the head of the user, and one or more non-contact sensors disposed on one of the frame, the display, the retention mechanism, and/or the front head-engaging structure. The one or more non-contact sensors may be non-contact capacitive proximity sensors and may be configured to detect a measurement of a head of a user (a head circumference, a head width, a head length, a head shape or contour, a nose bridge measurement, a forehead shape, or other feature of a head, face, or neck of a user.).

As used herein, the term “frame” includes a housing or enclosure that houses one or more components of the head-mounted device and/or a chassis, or other structure to which components of the head-mounted device are mounted or coupled to. In examples, the retention mechanism may comprise a strap, a band, temple arms, a clip, or other components configured to secure the frame to the head of the user. In at least one example, the retention mechanism may be associated with an adjustment mechanism configured to automatically adjust a length or other dimension of the retention mechanism based in part on a head circumference measurement.

In examples, one or more non-contact sensors may be disposed on various positions of the head-mounted device, including one or more of the frame, the retention mechanism, a display, a front head-engaging structure, a rear head-engaging structure, etc. For example, a first non-contact sensor disposed at a first position on a frame of the head-mounted device may be configured to detect a first measurement of the head of the user while a second non-contact sensor disposed at a second position on the frame of the device may be configured to detect a second measurement of the head of the user. In examples, the non-contact sensor(s) disposed on the head-mounted device may be of the same of different type. In examples, the non-contact sensors may have the same or different sensing ranges or may be adjustable to different sensing ranges. In some examples, the non-contact sensor(s) may be configured to be repositionable on the head-mounted device. In some examples, a non-contact sensor may be coupled to an adjustable control fixture configured to control a distance of the non-contact sensor relative to the head-mounted device. In some examples, the non-contact sensors may be at least partially covered by a material.

Features from any of the above-mentioned examples may be used in combination with one another in accordance with the general principles described herein. These and other examples, features, and advantages will be more fully understood upon reading the following detailed description in conjunction with the accompanying figures and claims.

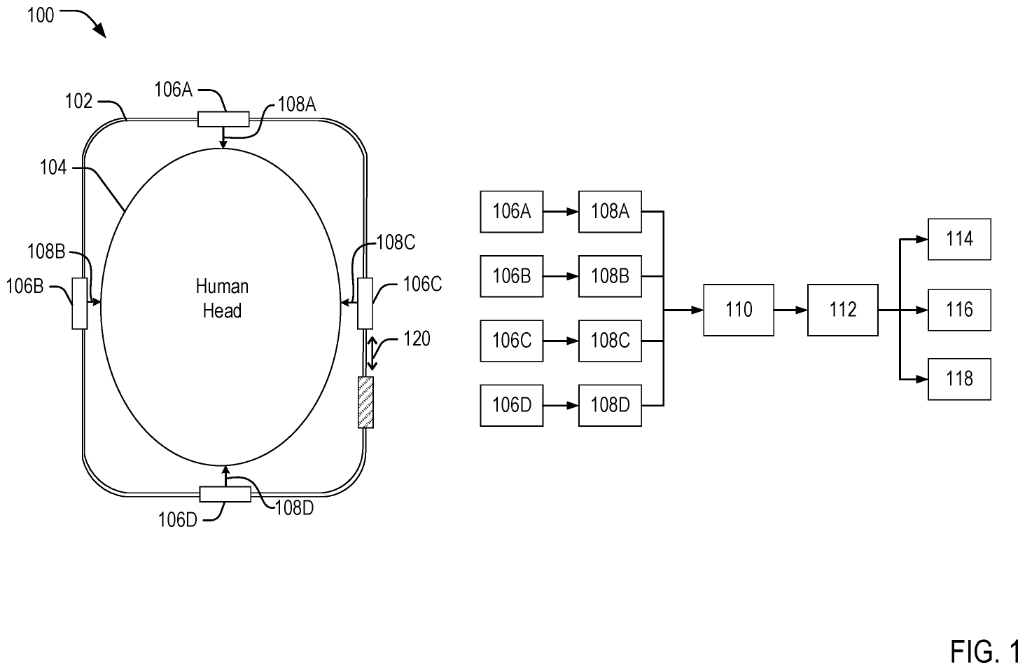

FIG. 1 is a schematic diagram of a head measurement system 100 in accordance with an example of the present disclosure. In some examples, the head measurement system 100 may include a frame 102, a retention mechanism coupled to the frame 102, and one or more sensors (e.g., sensors 106A, 106B, 106C, and 106D) coupled to the frame 102 and/or the retention mechanism 104.

In some examples, the frame 102 may be an external frame of a head-mounted device. The frame 102 may be substantially rigid and define a general exterior shape of the head measurement system 100. The material of the frame 102 may include polycarbonate ABS alloy (PC/ABS), a thermoplastic such as acrylonitrile butadiene styrene (ABS), polycarbonate (PC), aliphatic polyamides (PA, PPA), polyoxymethylene (POM), polymethyl methacrylate (PMMA), polypropylene (PP), polybutylene terephthalate (PBT), polyphenylsulfone (PPSU), polyether ether ketone (PEEK), polyetherimide (PEI), metal (e.g., aluminum, magnesium, titanium, etc.), carbon fiber, fiberglass, combinations of any of these, or other materials. This enables the frame 102 to maintain a rigid shape while still allowing the frame 102 to be secured to a retention mechanism. In some examples, the frame 102 can be dynamically adjustable to fit a head shape or size of any user.

Though the frame 102 in FIG. 1 is depicted as being a single piece, the frame may comprise of multiple pieces in some instances. For example, the frame 102 may comprise a first portion and a second portion (not shown), wherein the first portion can be slidably received into a slot associated with the second portion of the frame. Such an example enables a length or size of the frame 102 to be adjustable. Though the frame 102 in FIG. 1 is depicted as being level (i.e., on a single plane), in some instances the frame 102 may be non-planar where portions of the frame 102 extend in a different x-axis, y-axis, and/or z-axis directions relative to each other.

In some examples, a retention mechanism 104 may be coupled to the frame 102 in a manner that enables the retention mechanism to change size or length relative to the frame 102. In examples, the retention mechanism may comprise an elastomeric material, including relatively hard elastomeric materials such as polyamide, polypropylene, polyurethane and/or polyethylene, etc. and/or relatively soft material such as a natural material (rubber, silk cork, wool, felt, etc.), a synthetic material (e.g., styrene-butadiene black copolymers, polyisoprene, ethylene propylene rubber, ethylene propylene diene rubber, silicone elastomers, fluor elastomers, polyurethane elastomers, and nitrile rubbers, neoprene, polyester, etc.), or a metal (e.g., a braided metal or flexible metal strip). In at least one example, the retention mechanism comprises a flexible strap that maintains flexibility and holds tension without substantially stretching along the length of the flexible strap.

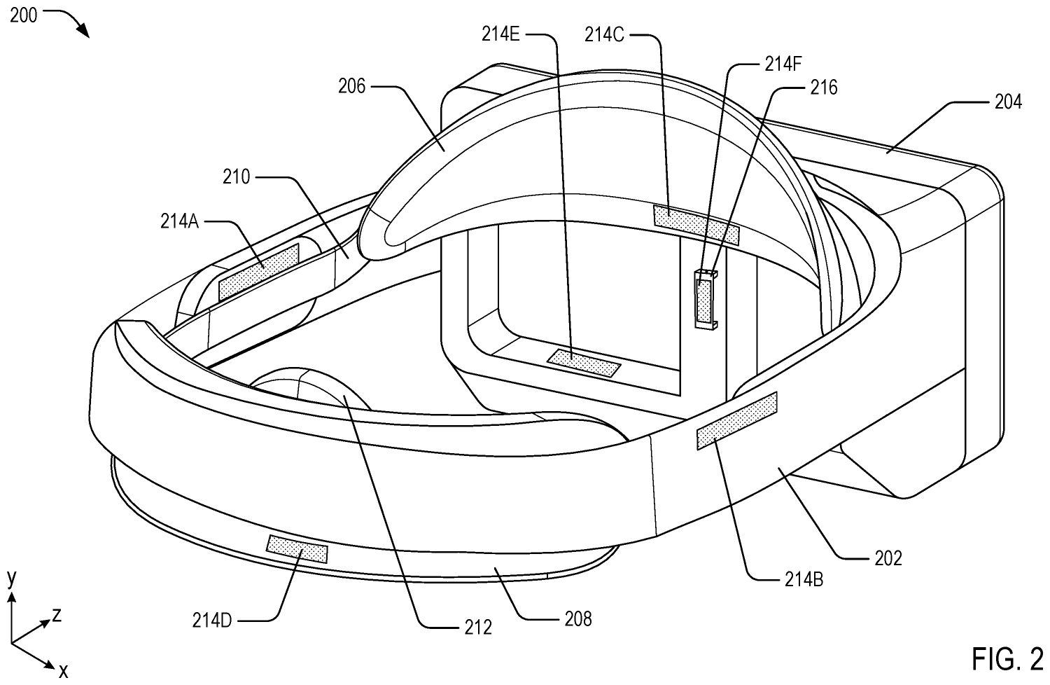

The retention mechanism 104 may be adjustable in order to accommodate and fit different head sizes and shapes. In some examples, the retention mechanism may be associated with an adjustment mechanism (not shown). In examples, the adjustment mechanism may include a ratcheting mechanism that enables a user to tighten and/or loosen the retention mechanism. The adjustment mechanism may be manually actuated by means of physical manipulation of the user, manually actuated by means of a user activating a motorized actuator, or automatically actuated by a motorized actuator under control of a processor or controller of the head measurement system 100 or other device. Further discussion of an example adjustment mechanism is discussed below in relation to FIGS. 2-4.

Head measurement system 100 may include one or more sensors (e.g., sensor 106A, 106B, 106C, and 106D) disposed at various locations on the head measurement system 100. Though four sensors are shown in FIG. 1, any number of sensors may be included in the head measurement system (e.g., 1, 2, 3, 5 sensors, etc.). The one or more sensors may be coupled to a rigid (or non-flexible) portion of the head measurement system, such as the frame 102, or a flexible and movable portion of the head measurement system, such as the retention mechanism 104.

The one or more sensors may include non-contact sensors and/or contact sensors. In examples, a non-contact sensor may include a capacitive sensor, ultrasound or ultrasonic sensor, inductive sensor, rotary sensor, optical sensor, proximity sensor, hall effect, infrared sensor, time-of-flight sensor, and the like. The head measurement system 100 may include one or more non-contact capacitive proximity sensors that detect a presence of an object or material as well as measure a distance, density, thickness, angle, and/or location of various materials (e.g., human skin, hair, plastic, metallic objects, liquids, wood, paper, glass, ceramic, cloth materials, etc.). A capacitive sensor may be used to determine when the head measuring system 100 is being worn by a user (as opposed to being placed on a table, hung on a wall, stored in a container or backpack, etc.) due to the capacitive sensor's ability to detect the presence of various materials including human skin or hair. The non-contact capacitive proximity sensors are also configured to detect skin even when the user is wearing a hat, cap, hoodie, glasses, goggles, etc. in addition to the head measuring system.

In some examples, sensor(s) 106A, 106B, 106C, and 106D may be sensors of the same or different type. A sensor type may include a contact sensor, non-contact sensor, capacitive sensor, inductive sensor, rotary sensor, optical sensor, proximity sensor, hall effect, ultrasonic, infrared sensor, temperature sensor, pressure sensor, and the like. For example, sensor 106A may be a non-contact temperature sensor positioned at a front of the head measurement system (i.e., proximate a side of the head measurement system configured to face a forehead or face of a user) and utilized to measure a body temperature of a user wearing the head measurement system 100, while sensor 106D may be a non-contact capacitive sensor configured to measure a head circumference or head shape. In some examples, the one or more sensors may be of the same or different size or have the same or different sensing ranges.

In some examples, one or more sensors (e.g., sensor 106A, 106B, 106C, and/or 106D) may be configured to be repositionable on the frame 102 and/or the retention mechanism 104. For example, sensor 106C may be repositioned from a first position on the frame 102 to a second position (e.g., see arrow 120). In examples, sensor 106C may be configured to be removable from the head measurement system 100 so that it may be repositioned on a different location on the frame 102 or retention mechanism 104 (or removed from the head measurement system 100 altogether so that it can be replaced due to damage). In some examples, one or more sensors may be associated with a housing that is removable or repositionable on the frame 102. In at least one example, a sensor may be associated with a sensor housing that is configured be slidable from a first position to a second position on the frame 102. In examples, sensor 106C or a sensor housing associated with sensor 106C may include a locking mechanism configured to lock the sensor 106C in a position on the frame 102 or retention mechanism 104.

In some examples, the one or more sensors may have an adjustable sensing range and may be associated with an adjustment screw that adjusts the sensing range. In some examples, the one or more sensors may be adjusted to different sensing ranges. For example, sensor 106A may be positioned on the frame 102 so that it is a first distance from the retention mechanism 104 and sensor 106B may be positioned a second distance from the retention mechanism 104, wherein the second distance is different (i.e., greater or lesser than) than the first distance. In some examples, the one or more sensors (e.g., sensor 106A, 106B, 106C, and/or 106D) may have the same or different fields of view or sensing ranges. The sensing range of a sensor may be related to a sensing area of the sensor. In some examples, the sensing area of the sensors described herein may be between about 50 mm² to about 800 mm², though in other examples sensors having smaller or larger areas may be used. In at least one example, the sensing area of at least one of the one or more sensors may be about 200 mm². In some examples, multiple sensors may be used and the sensing areas of each of the sensors may be substantially the same, while in other examples the sensing area of at least some of the multiple sensors may be different than at least some other of the multiple sensors. In some examples, the one or more sensors may be positioned at different distances relative to a head of a user, relative to the frame, and/or relative to the retention mechanism. In some examples, the one or more sensors may be configured to generate sensor data or measurements from a distance of about 2 mm to about 50 mm relative to the head of a user.

The sensor(s) 106A, 106B, 106C, 106D may be disposed at various locations on the frame and/or the retention mechanism. For example, sensor 106A and sensor 106D are positioned opposite each other on the frame 102 while sensor 106B and sensor 106C are positioned opposite each other on the frame 102. In some examples, the sensors 106A, 106B, 106C, 106D may be positioned on the frame 102 so that the sensors are spaced equally or unequally relative to one another other.

The sensor(s) 106A, 106B, 106C, 106D may be configured to generate sensor data. For example, the sensors 106A, 106B, 106C, 106D may generate head data including measured distances 108A, 108B, 108C, and/or 108D representing a distance from the sensor to a head of a user. The measured distances 108A, 108B, 108C, and 108D may be input and processed by an algorithm(s) 110, function(s), model(s), neural network(s), and/or machine-learning algorithm(s). The algorithm 110 is used to generate an output 112. In some examples, the output 112 may be a head circumference, head size measurement (e.g., a head width and/or head length measurement), a head shape or head contour measurement, a hat size, a nose bridge measurement, forehead shape, an interpupillary distance, etc. which may be utilized for different purposes. A head width or head length may be measured by taking a distance from opposite sides of the user's head. The output 112 from the algorithm 110 may be used to dynamically adjust a strap 114 of an extended reality headset, adjust a therapy helmet 116, help a user with an online hat order 118, help with an online glasses order, adjust a temple size or nose bridge size of a pair of glasses, and the like. In some examples, different algorithms may be used based on a desired output (e.g., a first algorithm may be used to output a head circumference and a second algorithm may be used to output an interpupillary distance).

In some examples, the sensor data and/or head measurements may be presented to a user via a display associated with the head measurement system 100. For example, the head measurement system 100 may be associated with an application that presents the sensor data and/or head measurements via a computer interface or display (not shown). In some examples, the head measurement system 100 may be associated with a data transmission interface that enables a user to send data to an external electronic device (e.g., a computer, tablet, smart phone, data storage system, cloud, etc.) via a network (e.g., a wireless personal area network (WPAN), Bluetooth, WiFi, ethernet, USB, etc.). In some examples, the data may be stored in a database.

FIG. 2 is perspective view of an example head-mounted device 200 including one or more non-capacitive sensors in accordance with an example of the present disclosure. The term “head-mounted device” as used herein, generally refers to a type or form of display device or system that is worn on or about a user's head and, in some examples, can display visual content to the user. In examples, the head-mounted device 200 may be an extended reality (e.g., a virtual reality, augmented reality, mixed reality, etc.) headset. The head-mounted device 200 may include one or more of an external frame 202, a display structure 204, a front head-engaging structure 206, a rear head-engaging structure 208, a retention mechanism 210, an adjustment mechanism 212, and/or one or more sensors (e.g., sensor 214A, 214B, 214C, 214D, 214E, 214F).

In examples, the substantially rigid external frame 202 may define a general shape of the head-mounted device 200. In examples, the external frame 202 may comprise of a single frame piece or multiple frame pieces. The external frame 202 can support and stabilize a display structure 204 relative to a head of a user.

The display structure 204 coupled to the external frame 202 may include one or more display devices (e.g., an electronic display screen, projector, lenses, head-up display, etc.) capable of displaying computer generated content (e.g., an extended reality presentation). The display structure 204 can be located at a front end of the head-mounted device 200 and positioned such that a top end of the display structure contacts at least a portion of a forehead of a user and extends to cover at least a portion of the user's eyes. The display structure 204 includes a content delivery system which can present media on a presentation surface. The content delivery system can include a near eye display (NED) to be worn on the face of the user such that visual content is presented to the user (e.g., one or more images or video).

In some examples, the head-mounted device may include a front head-engaging structure 206 located at a front of the head-mounted device 200. The front head-engaging structure 206 may be coupled to the frame 102 via a pivot point that enables the front head-engaging structure 206 to be repositioned on a head of a user. The front head-engaging structure 206 can be configured to contact at least a portion of a forehead of a user. In examples, the front head-engaging structure 206 can be covered in a cushioned material (e.g., polyethylene, polyurethane, melamine foam, etc.) such that the front head-engaging structure 206 can comfortably conform to the user's forehead.

In some examples, the head-mounted device 200 may include a rear head-engaging structure 208 to provide additional comfort and stabilization. The rear head-engaging structure 208 is located at the back of the head-mounted device 200. In examples, at least a portion of the retention mechanism (e.g., one or more straps) can be slidable received into a slot of the rear head-engaging structure 208. The rear head-engaging structure 208 can be coupled to the external frame 202 via an attachment point (not shown) such that the rear head-engaging structure 208 can rotate clockwise and/or counterclockwise on the attachment point. In various examples, the attachment point can couple the retention mechanism 210 to the external frame 202. Similar to the front head-engaging structure 206, the rear head-engaging structure 208 can be made of a material configured to conform to the back of the user's head, such as polyethylene, polyurethane, and/or melamine foam, to name a few non-limiting examples.

In some examples, the head-mounted device 200 may include a retention mechanism 210. In examples, the retention mechanism 210 may comprise one or more flexible straps. In examples, the retention mechanism 210 may be at least partially coupled to the external frame 202. The retention mechanism 210 may be at least partially disposed inside the external frame 202 such that the retention mechanism 210 is located proximate the external frame 202 and the head of the user when in use. The retention mechanism 210 may be formed from one or more elastomeric materials, such as any of the material listed above in relation to FIG. 1 or discussed throughout this application. In examples, the retention mechanism 210 may be coupled to a front head-engaging structure and/or a rear head-engaging structure such that adjusting a length of the retention mechanism 210 moves the front head-engaging structure and/or a rear head-engaging structure closer or farther away from the head of the user.

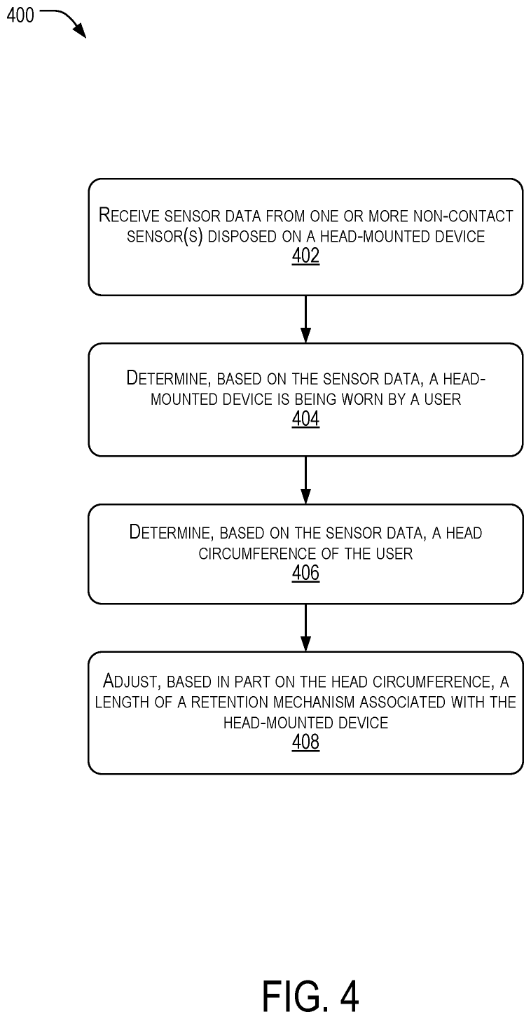

In some examples, the head-mounted device 200 may include an adjustment mechanism 212 configured to adjust a length of the retention mechanism 210. For example, the adjustment mechanism 212 may include a telescoping mechanism that can allow the retention mechanism 210 to move in a direction away from or towards the head of a user. In examples, the adjustment mechanism 212 can represent a ratcheting mechanism. In some examples, the adjustment mechanism 212 can enable a user to manually adjust a length of the retention mechanism (e.g., by rotating the adjustment mechanism 212 clockwise or counterclockwise). In some examples, the adjustment mechanism 212 may automatically adjust, based in part on a measured head circumference or size of a head of user, a length of the retention mechanism 210. An adjustment mechanism is discussed in further detail below in relation to FIG. 4.

In some examples, the head-mounted device may include one or more sensors (e.g., sensors 214A, 214B, 214C, 214D, 214E, 214F). The one or more sensors may be contact sensors, non-contact sensors, or any other sensor as discussed above in relation to FIG. 1. In at least one example, one or more of sensors 214A, 214B, 214C, 214D, 214E, and/or 214F may be non-contact capacitive proximity sensor(s). A capacitive sensor may be used to determine when the head-mounted device 200 is being worn by a user, as opposed to being placed on a table, hung on a wall, stored in a container, etc. In some examples, the head-mounted device 200 may control one or more operations (e.g., turning the display on or off, turning audio on or off, etc.) based in part on determining that the head-mounted device 200 is being worn by a user (e.g., by detecting skin or hair). This may prevent the head-mounted device from unnecessarily powering the device and using up battery life.

In some examples, one or more of the sensors 214A, 214B, 214C, 214D, 214E, and/or 214F may be partially or fully covered by a material. The material may include, for example, a cushioning material (e.g., polyethylene, polyurethane, melamine foam, etc.), a natural material (e.g., cotton, rubber, silk, cork, wool, felt, etc.), or a synthetic material (e.g., spandex, polyester, nylon, microfiber, fleece, modal, Kevlar, polyethylene, olefin fiber, modacrylic, lyocell, neoprene, styrene-butadiene block copolymers, polyisoprene, ethylene propylene rubber, ethylene propylene diene rubber, silicone elastomers, fluoroelastomers, polyurethane elastomers, and nitrile rubbers, polyester, etc.) or any other material included in the head-mounted device and discussed throughout the application.

Sensors 214A, 214B, 214C, 214D, 214E, and 214F may be disposed anywhere on the head-mounted device 200 including, for example, the external frame 202, display structure 204, front head-engaging structure 206, rear head-engaging structure 208, retention mechanism 210, adjustment mechanism 212, etc. Sensors 214A, 214B, 214C, 214D, 214E, and/or 214F may be used to measure various distances or features of a face or head of a user. Though FIG. 2 appear to depict some of the sensors as being disposed on an outside of the exterior frame 202, this is merely illustrative and sensors 214A, 214B, 214C, 214D, 214E, and/or 214F are disposed on the head-mounted device 200 such that they are capable of generating a measurement of a head of a user.

Though FIG. 2 depicts six sensors (sensors 214A, 214B, 214C, 214D, 214E, and 214F) as being disposed on the head-mounted device 200, fewer or more sensors may be used. For example, a first sensor (e.g., sensor 214A) may be disposed at a first position on the external frame 202 proximate the retention mechanism 210 (e.g., above, below, or at least partially behind the retention mechanism 210). Sensor 214A may be configured to measure a distance to a side of a user's head (e.g., a left temple area). In at least one example, sensor 214A may be disposed in a recess on the external frame 202, wherein the recess would prevent sensor 214A from directly contacting a portion of the head of the user. In at least one example, the recess may be at least partially covered by a material such as any of the materials discussed above. In some examples, the recess may be larger than a size of the sensor such that the sensor may be repositioned within the recess.

In examples, a second sensor (e.g., sensor 214B) may be disposed at a second position on the external frame 202, opposite sensor 214A. Sensor 214B may be configured to measure a distance to another side of a user's head (e.g., a right temple area). In examples, additional sensors not shown may be disposed on the external frame 202 of the head-mounted device 200 and configured to detect various measurements of the head of the user.

In examples, one or more sensors may be disposed on the front head-engaging structure 206. For example, sensor 214C is disposed on a bottom portion of the front head-engaging structure 206 and configured to measure a distance to a forehead of user and/or a forehead shape or contour. In at least one example, the sensor 214C is at least partially covered by a material that covers the front head-engaging structure 206.

In examples, one or more sensors may be disposed on the rear head-engaging structure 208. For example, sensor 214D is disposed on a bottom portion of rear head-engaging structure 208, proximate adjustment mechanism 212. In at least one example, sensor 214D is at least partially covered by a material that covers the rear head-engaging structure 208.

In examples, one or more sensors may be disposed on the display structure 204. For example, sensor 214E is disposed proximate a lens associated with the display structure 204. Sensor 214E may be configured to measure how close a user's face is to a lens of the display structure. Sensor 214F may be disposed on a middle portion of the display structure (e.g., between two lenses) and may be configured to measure a distance to a face or eye(s) of a user, an interpupillary distance, etc.

In examples, an adjustable control fixture 216 may be coupled to the non-contact sensor and configured to control a distance of the non-contact sensor relative to the head of the user. For example, sensor 214F is coupled to control fixture 216. The control fixture 216 may be disposed on any portion of the head-mounted device 200. For example, as shown in FIG. 2, the control fixture 216 may be disposed on a middle portion of the display structure 204.

Sensor data generated by sensors 214A, 214B, 214C, 214D, 214E, and/or 214F may be input into algorithm (e.g., algorithm 110 as discussed in relation to FIG. 1), function(s), model(s), neural network(s), and/or machine-learning algorithm(s). The algorithm is used to process the detected sensor measurements and generate an output. The output may include a head circumference, head size measurement (e.g., a head width and/or head length measurement), a head shape measurement, a hat size, a nose bridge measurement, forehead shape, etc. which may be used for different purposes. For example, a head circumference output from the algorithm may be used to adjust a length of the retention mechanism 210, adjust a position of a front head-engaging structure 206, a rear head-engaging structure 208, or a display structure relative to the head of the user. An interpupillary distance, nose bridge measurement, or other measurement output from the algorithm may be used to automatically reposition a display structure relative to a face of the user.

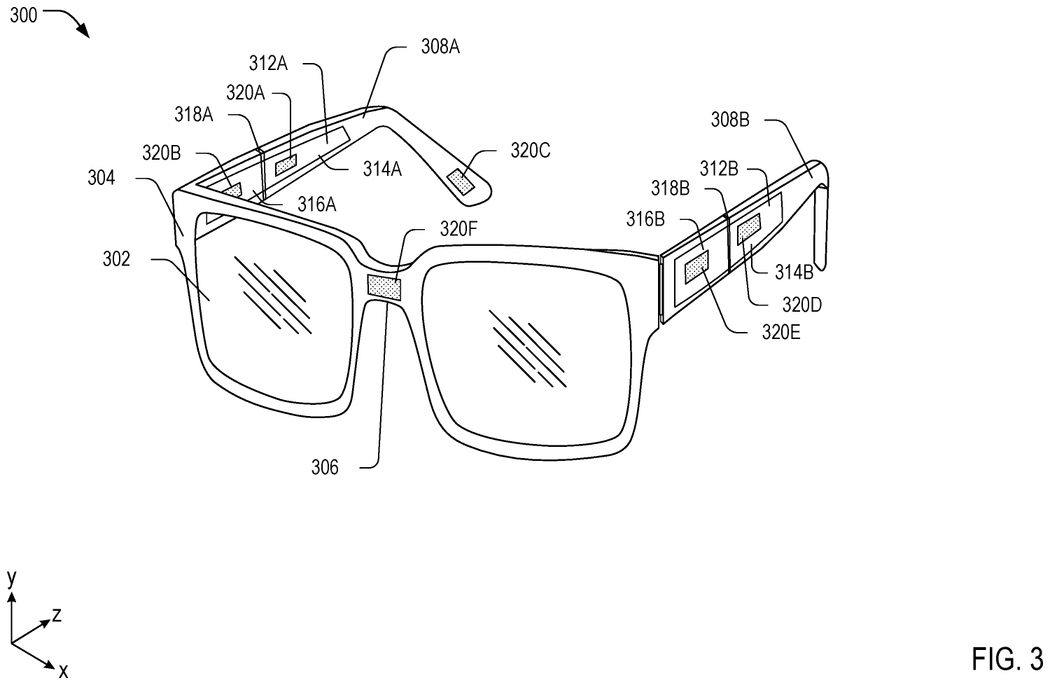

FIG. 3 is a perspective view of another example head-mounted device 300 including one or more non-capacitive sensors in accordance with an example of the present disclosure. The head-mounted device 300 may include one or more lenses 302 (right and left eye lenses) secured to a housing 304 that surrounds the lenses 302. The lenses 302 may be transparent or semi-transparent, allowing a user to view their external environment through the lenses 302. In some examples, the lenses 302 may be a customized optical power to provide vision correction to the user. In various examples, the lenses 302 may also function as displays, such as near-eye displays, that include or utilize a display system (e.g., a projection display system) to present media to a user. Examples of media presented by the lenses 302 include one or more images, a series of images (e.g., video), or some combination thereof.

In some examples, the housing 304 surrounding the lenses 302 may be a frame of eye-wear glasses that may secure the lenses 302 in place on the head of a user. A nose bridge 306 of the housing 304 between the lenses 302 may be sized to fit over and rest on the top of the bridge of a user's nose. A first temple 308A and a second temple 308B may be coupled to the housing 304 and configured to rest on, behind, and/or wrap at least partially around the ears of the user. The housing 304 and/or the temples may be at least partially hollow to accommodate electronic components (e.g., sensors, processors, memory, radios, antennas, projectors or other display components, batteries or other energy storage devices, printed circuit boards, integrated circuits, wires, cables, and/or other components).

In some examples, a first temple 308A may be associated with a first adjustment mechanism 312A and a second temple 308B may be associated with a second adjustment mechanism 312B. The first adjustment mechanism 312A may be used to adjust a length of the first temple 308A and the second adjustment mechanism 312B may be used to adjust a length of the second temple 308B. For example, the first adjustment mechanism 312A may comprise of a first portion 314A and a second portion 316A, where the first portion 314A may be slidably received into a slot of the second portion 316A. In some examples, a third portion 318A may be positioned in between the first portion 314A and the second portion 316A such that the first portion 314A and the second portion 316A extend from the third portion 318A. In some examples, the first adjustment mechanism 312A and/or the second adjustment mechanism 312B may enable a user to manually adjust a length of the first temple 308A and/or the second temple 308B. In some examples, the first adjustment mechanism 312A and/or the second adjustment mechanism 312B may be associated with a motor that dynamically adjusts a length of the first temple 308A and/or the second temple 308B based at least in part on sensor data received from one or more sensors associated with the head-mounted device 300. Similar to the first adjustment mechanism, the second adjustment mechanism 312B may be associated with a first portion 314B, a second portion 316B, and/or a third portion 318B.

In some examples, the head-mounted device 300 may include one or more sensors (e.g., sensors 320A, 320B, 320C, 320D, 320E, 320F). The one or more sensors may be contact sensors, non-contact sensors, or any other sensor as described in relation to FIGS. 1 and 2. Though FIG. 3 depicts six sensors disposed on the head-mounted device 300, fewer or more sensors may be used. In some examples, one or more sensors may be disposed within a recess on the housing 304, first temple 308A, second temple 308B, and/or nose bridge 306, etc.

Sensors 320A, 320B, 320C, 320D, 320E, and/or 320F may be used to measure various distances or features of a face or head of a user. For example, sensor 320A and sensor 320B may be used to measure a distance to a right temple of a user. Sensor 320C may be used to measure a distance to or shape of a nose bridge of a user. Sensor 320D and sensor 320E may be used to measure a distance to a left temple of a user. Sensor data received from sensors 320A, 320B, 320C, 320D, 320E, and/or 320F may be input into one or more algorithms (e.g., algorithm 110 as described in relation to FIG. 1) and output a head circumference, head size measurement (e.g., a head width measurement), a head shape measurement, a glasses size, a nose bridge measurement, or any other measurement as described throughout this application. In at least one example, an algorithm may output a head circumference measurement that may be used to dynamically adjust a length of the first temple 308A and/or the second temple 308B using the first adjustment mechanism 312A and/or the second adjustment mechanism 312B.

In some examples, the head-mounted device 300 may include other components not shown in FIG. 3. For example, head-mounted device 300 may include one or more of processors, central processing units (CPUs), graphics processing units (GPUs), holographic processing units, microprocessors, microcontrollers, integrated circuits, motors, memory, batteries, or other components as discussed throughout this application.

FIG. 4 illustrates an example method 400 for adjusting a length of a retention mechanism associated with a head-mounted device as described herein. In some instances, some or all of the method 400 may be performed by one or more components discussed with respect to FIGS. 1-3. However, the method 400 is not limited to be performed by components described with respect to FIGS. 1-3.

Referring to FIG. 4, in some examples, at step 402, the method 400 can include receiving sensor data from one or more non-contact sensor(s) disposed at various locations on a head-mounted device. In some examples, the one or more non-contact sensors may be non-contact capacitive sensors configured to measure a distance to a head of a user, a head shape, head or facial contours, etc. In at least one example, four non-contact capacitive sensors are disposed at four different positions on the head-mounted device (e.g., a frame, a retention mechanism, a display structure, a head-engaging structure, a rear engaging structure, a temple, a nose bridge, etc.) and are configured to detect head measurements of a head of a user. A first non-contact capacitive sensor and a second non-contact capacitive sensor opposite the first non-contact capacitive sensor may be configured to measure a head width while a third non-contact sensor and a fourth non-contact capacitive sensor opposite the third non-contact capacitive sensor may be configured to measure a head length.

In some examples, at step 404, the method 400 can include determining, based at least in part on the sensor data, a head-mounted device is being worn by a user (as opposed to being placed on a table, hung on a wall, stored in a container or backpack, etc.). For example, one or more non-contact capacitive sensors may detect various materials (e.g., skin, hair, plastic, metallic objects, liquids, wood, paper, glass, ceramic, cloth or fabric materials, etc.) by measuring a characteristic impedance spectrum of the object or material to determine its properties. A non-contact capacitive sensor may detect the presence of various materials, including skin, by measuring changes in charge and discharge times, indicating a variation in capacitance. The head-mounted device 200 may control one or more operations (e.g., turning on the display, microphone, speaker, etc.) based in part on determining that the head-mounted device 200 is being worn by a user. This may prevent the head-mounted device from unnecessarily powering the device and using up battery life when the device is not being worn. In some examples, the head-mounted device may power on the device based in part on two or more non-contact capacitive sensors detecting the skin or hair of a user.

In some examples, at step 406, the method 400 can include determining, based in part on the sensor data, a head circumference of the user wearing the head-mounted device. For example, sensor data received from one or more non-contact capacitive sensors may processed by an algorithm, function(s), model(s), neural network(s), and/or machine-learning algorithm(s) and used to output one of a head circumference, head size measurement (e.g., a head width and/or head length measurement), a head shape measurement, a hat size, a nose bridge measurement, etc. In at least one example, a head circumference may be stored in a memory of the head-mounted device.

In some examples, at step 408, the method 400 can include adjusting, based in part on the head circumference, a length of a retention mechanism associated with the head-mounted device. For example, the length of the retention mechanism may be adjusted from a first length to a second length to match the measured head-circumference of a user in order to provide a better, more comfortable fit.

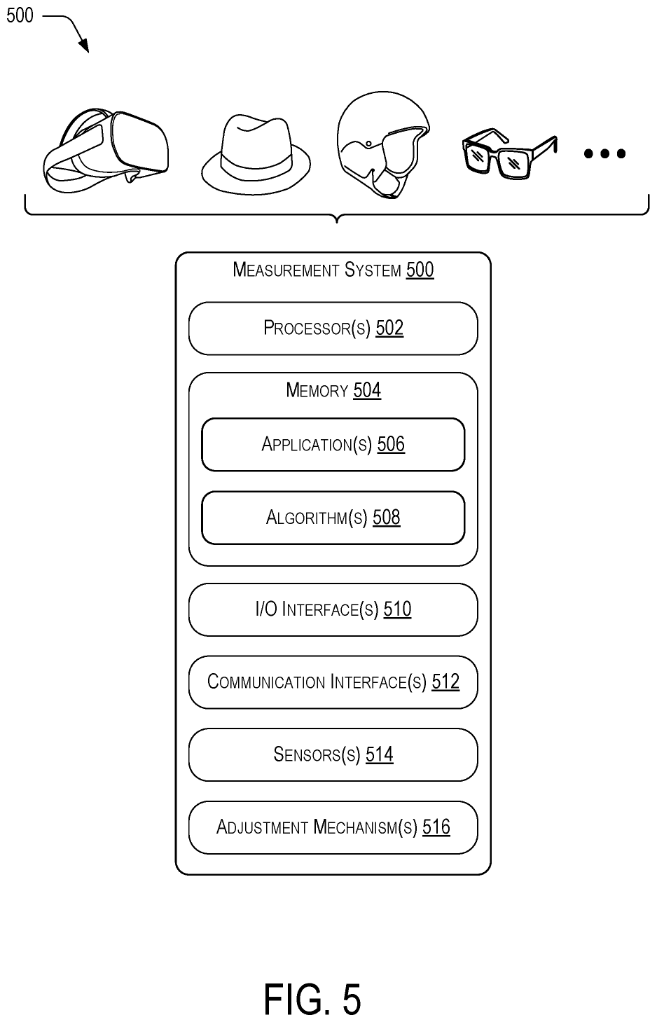

FIG. 5 illustrates an example measurement system 500 usable to implement techniques such as those described herein. The measurement system 500 may be associated with a wearable device. In some examples, a wearable device may include a head-mounted device such as an extended reality headset, glasses, a hat, a helmet. In some examples, the wearable device may include a wristband, or a watch configured to measure a wrist size, shape, and/or circumference of a user's wrist. In some examples, the wearable device may be a belt configured to measure a waste size and/or waste circumference of a user.

As shown, the measurement system 500 may include one or more electronic components such as processor(s) 502, memory 504, input/output interfaces 510 (or “I/O interfaces 510”), communication interface(s) 512, sensor(s) 514, and/or adjustment mechanism(s) 516 which may be communicatively coupled to one another by way of a communication infrastructure (e.g., a bus, traces, wires, etc.). The memory 504 may be associated with application(s) 506 and/or algorithm(s) 508. The components illustrated in FIG. 5 are not intended to be limiting and the various components can be rearranged, combined, and/or omitted depending on the requirements for a particular application or function. Additional or alternative components may be used in other examples.

The processor(s) 502 may include hardware for executing instructions, such as those making up a computer program or application. For example, to execute instructions, the processor(s) 502 may retrieve (or fetch) the instructions from an internal register, an internal cache, the memory 504, or other computer-readable media, and decode and execute them. By way of example and not limitation, the processor(s) 502 may comprise one or more central processing units (CPUs), graphics processing units (GPUs), holographic processing units, microprocessors, microcontrollers, integrated circuits, programmable gate arrays, or other hardware components usable to execute instructions.

The memory 504 is an example of computer-readable media and is communicatively coupled to the processor(s) 502 for storing data, metadata, and programs for execution by the processor(s) 502. In some examples, the memory 504 may constitute non-transitory computer-readable media such as one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 504 may include multiple instances of memory and may include internal and/or distributed memory. The memory 504 may include removable and/or non-removable storage. The memory 504 may additionally or alternatively include one or more hard disk drives (HDDs), flash memory, Universal Serial Bus (USB) drives, or a combination these or other storage devices.

The memory 504 may store one or more application(s) 506, which may include, among other things, an operating system (OS), productivity applications (e.g., word processing applications), communication applications (e.g., email, messaging, social networking applications, etc.), games, or the like. The application(s) 506 may be implemented as one or more stand-alone applications, as one or more modules of an application, as one or more plug-ins, as one or more library functions application programming interfaces (APIs) that may be called by other applications, and/or as a cloud-computing model. The application(s) 506 can include local applications configured to be executed locally on an electronic device, one or more web-based applications hosted on a remote server, and/or as one or more mobile device applications or “apps.”

The memory 504 may store one or more algorithm(s) 508, which may include machine learning algorithms, artificial neural network (ANN) algorithms, regressions algorithms. The algorithm 508 may be configured to receive a distance measurement as input, convert the measurements from a distance to an electrical signal that can be read by a microcontroller, process the signal into letters and numbers using an analog to digital converter (ADC), and generate an output. The output, in some examples, may include a head circumference, head size measurement (e.g., a head width and/or head length measurement), a head shape measurement, a hat size, a nose bridge measurement, and the like.

The measurement system 500 may include one or more I/O interface(s) 510, which are provided to allow a user to provide input to (such as touch inputs, gesture inputs, keystrokes, voice inputs, etc.), receive output from (e.g., sensor data and/or a measurement of a head of a user), and otherwise transfer data to and from the measurement system 500. Depending on the particular configuration and function of the measurement system 500, the I/O interface(s) 510 may include one or more input interfaces such as keyboards or keypads, mice, styluses, touch screens, cameras, microphones, accelerometers, gyroscopes, inertial measurement units, optical scanners, other sensors, controllers (e.g., handheld controllers, remote controls, gaming controllers, etc.), network interfaces, modems, other known I/O devices or a combination of such I/O interface(s) 510. Touch screens, when included, may be activated with a stylus, finger, thumb, or other object. The I/O interface(s) 510 may also include one or more output interfaces for presenting output to a user, including, but not limited to, a graphics engine, a display (e.g., a display screen, projector, holographic display, etc.), one or more output drivers (e.g., display drivers), one or more audio speakers, and one or more audio drivers. In certain examples, I/O interface(s) 510 are configured to provide graphical data to a display for presentation to a user. The graphical data may be representative of one or more graphical user interfaces and/or any other graphical content as may serve a particular implementation. By way of example, the I/O interface(s) 510 may include or be included in a wearable device, such as a head-mounted device or display (e.g., headset, glasses, helmet, visor, etc.), a suit, a wrist band, a watch, or any combination of these. In some examples, the I/O interface(s) 510 may be configured to provide an extended reality environment or other computer-generated environment. As used herein, an extended reality environment includes an at least partially computer-generated environment, such as virtual reality, augmented reality, and/or mixed reality, and extended reality devices or headsets are devices configured to provide all or a portion of an extended reality environment.

The measurement system 500 may include one or more communication interface(s) 512. The communication interface(s) 512 can include hardware, software, or both. In examples, communication interface(s) 512 may provide one or more interfaces for physical and/or logical communication (such as, for example, packet-based communication) between the measurement system 500 and one or more other electronic devices or one or more networks. As an example, and not by way of limitation, the communication interface(s) 512 may include a network interface controller (NIC) or network adapter for communicating with an Ethernet or other wire-based network and/or a wireless NIC (WNIC) or wireless adapter for communicating with a wireless network, such as a WI-FI adapter. In examples, communication interface(s) 512 can additionally include a bus, which can include hardware (e.g., wires, traces, radios, etc.), software, or both that communicatively couple components of the measurement system 500 to each other.

The measurement system 500 may also include one or more sensor(s) 514 as described throughout the application. For example, the one or more sensor(s) may include non-contact capacitive sensors, inductive sensors, rotary sensors, optical sensors, proximity sensors, hall effects, ultrasonic, infrared sensors, time-of-flight sensors, and the like.

The measurement system 500 may also include one or more adjustment mechanism(s) 516. An adjustment mechanism may include one or more straps. A strap length may be manually adjusted to a desired length (e.g., using a ratcheting mechanism) or automatically adjusted based on a measured head circumference.

In examples, the measurement system 500 may include additional or alternative components that are not shown, such as, but not limited to, a power supply (e.g., batteries, capacitors, etc.), a housing or other enclosure to at least partially house or enclose any or all of the components.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

Further, the specific features and acts are disclosed as exemplary forms of implementing the claims. For example, the structural features and/or methodological acts may be rearranged and/or combined with each other and/or other structural features and/or methodological acts. In various examples, one or more of the structural features and/or methodological acts may be omitted.

What is claimed is:

1. A head-mounted device comprising:
a frame;
a display coupled to the frame and configured to present computer-generated content;
a front head-engaging structure coupled to the frame and configured to engage a front portion of a head of a user;
a retention mechanism configured to secure the front head-engaging structure to the head of the user; and
a non-contact sensor disposed on at least one of the frame, the display, the retention mechanism, or the front head-engaging structure, the non-contact sensor configured to detect a measurement of the head of the user.

2. The head-mounted device of claim 1, wherein the non-contact sensor is a first non-contact sensor, the head-mounted device further comprising:
a second non-contact sensor disposed on the front head-engaging structure;
a third non-contact sensor disposed on the retention mechanism; and
a fourth non-contact sensor disposed on the frame.

3. The head-mounted device of claim 1, further comprising an adjustment mechanism configured to adjust, based in part on the measurement of the head of the user, a length of the retention mechanism.

4. The head-mounted device of claim 1, wherein the non-contact sensor is a first non-contact sensor, the head-mounted device further comprising:
a rear head-engaging structure;
a second non-contact sensor disposed on the rear head-engaging structure.

5. The head-mounted device of claim 1, further comprising:
an adjustable control fixture coupled to the non-contact sensor, the adjustable control fixture configured to control a distance of the non-contact sensor relative to the head of the user.

6. The head-mounted device of claim 1, wherein the non-contact sensor is a first non-contact sensor of a first type and the measurement is a first measurement, the head-mounted device further comprising:
a second non-contact sensor of a second type different than the first type, the second non-contact sensor disposed on one of the frame, the display, the retention mechanism, or the front head-engaging structure, the second non-contact sensor configured to detect a second measurement of the head of the user.

7. The head-mounted device of claim 1, wherein the non-contact sensor is a first non-contact sensor positioned a first distance from the head of the user, the head-mounted device further comprising:
a second non-contact sensor positioned a second distance from the head of the user.

8. The head-mounted device of claim 1, wherein the non-contact sensor is a capacitive sensor.

9. The head-mounted device of claim 1, further comprising a layer of material at least partially covering the non-contact sensor.

10. The head-mounted device of claim 1, wherein the measurement includes a size or shape of the head.

11. An extended reality device comprising:
a frame;
a retention mechanism coupled to the frame and configured to contact a head of a user;
a first non-contact sensor disposed at a first position on the frame, the first non-contact sensor configured to detect a first measurement of the head of the user;
a second non-contact sensor disposed at a second position on the frame, the second non-contact sensor configured to detect a second measurement of the head of the user; and
an adjustment mechanism coupled to the retention mechanism, the adjustment mechanism configured to automatically adjust a length of the retention mechanism based in part on the first measurement and the second measurement.

12. The extended reality device of claim 11, wherein the first non-contact sensor comprises a first capacitive sensor and the second non-contact sensor comprises a second capacitive sensor.

13. The extended reality device of claim 11, wherein at least one of the first non-contact sensor or the second non-contact sensor are configured to be repositionable on the frame.

14. The extended reality device of claim 11, further comprising:
a third non-contact sensor disposed at a third position on the frame, the third non-contact sensor configured to detect a third measurement of the head of the user; and
a fourth non-contact sensor disposed at a fourth position on the frame, the fourth non-contact sensor configured to detect a fourth measurement of the head of the user.

15. The extended reality device of claim 11, further comprising:
a display structure for displaying computer generated content; and
a third non-contact sensor disposed on the display structure, the third non-contact sensor configured to detect a third measurement of the head of the user.

16. A method comprising:
receiving sensor data from a non-contact sensor disposed on a head-mounted device, the head-mounted device having a retention mechanism configured to secure the head-mounted device to a head of a user;
determining, based in part on the sensor data, the head-mounted device is being worn by the user;
determining, based in part on the sensor data, a head circumference of the user; and
adjusting, based in part on the head circumference, a length of the retention mechanism from a first length to a second length.

17. The method of claim 16, wherein the sensor data is first sensor data and the non-contact sensor is a first non-contact sensor, the method further comprising:
receiving second sensor data from a second non-contact sensor disposed on the head-mounted device, and
wherein the determining the head circumference of the user is further based in part on the second sensor data.

18. The method of claim 16, wherein the head-mounted device comprises a display structure, the method further comprising:
determining, based in part on the sensor data, a distance between the display structure and the head of the user; and
adjusting, based in part on the distance, a position of the display structure relative to the head of the user.

19. The method of claim 16, wherein the non-contact sensor is at least partially covered by a material.

20. The method of claim 16, further comprising:
storing the head circumference of the user in a memory of the head-mounted device.
